(19) United States
(12) Patent Application Publication
(10) Pub. No.: US 2009/0125664 A1
(43) Pub. Date: May 14, 2009

(54) SYSTEM CONTROLLER

(76) Inventor: Takatoshi Ueyama, Osaka (JP)

Correspondence Address: MCDERMOTT WILL & EMERY LLP, 600 13TH STREET, NW, WASHINGTON, DC, 20005-3096, US

(21) Appl. No.: 12/096,473

(22) PCT Filed: Mar. 15, 2007
(86) PCT No.: PCT/JP2007/055220

§ 371 Date: Jun. 6, 2008

(30) Foreign Application Priority Data
Apr. 4, 2006 (JP) 2006 103167

(51) Int. Cl. G06F 13/00

(52) U.S. Cl. 710/305

(57) ABSTRACT

A system LSI section 901 having a new function includes an embedded system control microcomputer, but uses a microcomputer within an external microcomputer section 902 having an existing function as a system control microcomputer without using the embedded system control microcomputer. The external microcomputer section 902 outputs a bus request signal XEBRQ when attempting to acquire a system bus 904, receives a bus grant signal XEBGT from an arbitration section 901a within the system LSI section 901 that has received the request signal, and acquires the system bus 904. Then, the external microcomputer section 902 issues a read or write access request to the system LSI section 901 or a peripheral device section 903 using the system bus 904. Therefore, even in the case of adding a system LSI having a new function to a system having an existing function, the system can be reconstructed using previous design resources.

### TECHNICAL FIELD

The present invention relates to an improvement in a system controller in which, to impart an additional function to an external microcomputer having a predetermined function, a system LSI having the additional function is added to the external microcomputer.

### BACKGROUND ART

Conventionally, when a new function is to be added to an existing system, such as, e.g., when a digital television function is incorporated into an analog television set, when the digital television function is incorporated into a car navigation system, or the digital television function is incorporated into a personal computer, an addition of a system LSI having a system control microcomputer and the digital television function integrated in one chip has been performed.

When the system LSI is thus added, it is normal practice to control the use of a system bus using the system control microcomputer embedded in the system LSI in executing the function (e.g., the digital television function) of the system LSI. On the other hand, it has been a known technology to construct the system LSI having a multi-CPU embedded therein, such as, e.g., the technology described in Patent Document 1.
Patent Document 1:Japanese Laid-Open Patent Publication No. 2004-164113

### DISCLOSURE OF THE INVENTION

### Problem To Be Solved by the Invention

However, in the case of adding a new function with the addition of the system LSI, causing only the system control microcomputer embedded in the system LSI mentioned above to perform the control of the system bus for executing the new function has the problem that, in terms of system construction, there is no flexibility in selecting a microcomputer.

Even though the system LSI has a function which is particularly attractive to a system designer, the need to necessarily use the entirely new system control microcomputer embedded in the system LSI leads to the drawback that, as previous design resources are discarded, system reconstruction should be performed.

An object of the present invention is to use, even when a system LSI equipped with a system control microcomputer is added to an existing microcomputer, the system control microcomputer of the existing microcomputer in association with execution of the newly added function and allow even the system control microcomputer of the existing microcomputer to control the use of a system bus associated with execution of the new function of the system LSI mentioned above.

### Means for Solving the Problems

To attain the object described above, the present invention provides a structure which uses a system LSI having an embedded system control microcomputer, but allows an external system control microcomputer to indirectly control a system bus via the system LSI or allows the external system control microcomputer to directly control the system bus without using the system control microcomputer embedded in the system LSI in association with execution of the function of the system LSI.

Specifically, a system controller according to the present invention comprises: a system LSI section having a single or a plurality of functions integrated in one chip, and including an embedded system control microcomputer for controlling a system bus in association with execution of the functions; and an external microcomputer section, wherein the external microcomputer section has another system control microcomputer for controlling the system bus in association with execution of at least a part of the functions of the system LSI section.

In the system controller according to the present invention, the system LSI section comprises: an arbitration section for performing arbitration of an access to the system bus between itself and the external microcomputer section, wherein the system LSI section and the external microcomputer section share the system bus, and either one of the system control microcomputers controls the system bus through the access arbitration by the arbitration section.

In the system controller according to the present invention, the system LSI section receives an access request from the external microcomputer section using the arbitration section and a system bus interface, and controls a part of the functions of the system LSI section in response to the access request at a reception time thereof.

The system controller according to the present invention further comprises: a peripheral device section connected to the system bus, wherein the system bus LSI section receives an access request from the external microcomputer section to the peripheral device section using the arbitration section and a system bus interface, and performs an access to the peripheral device section in response to the access request at a reception time thereof.

In the system controller according to the present invention, the system LSI section and the peripheral device section output respective acknowledge signals at a completion of the access, the system controller. further comprising: an acknowledge signal control section for controlling the acknowledge signals outputted from the system LSI section and from the peripheral device section such that the acknowledge signals are not inputted to the external microcomputer section.

In the system controller according to the present invention, the acknowledge signal control section is provided inside the system LSI section.

The system controller according to the present invention further comprises: a read data signal control section for performing a control operation such that, when a read access request for data is issued from the external microcomputer section to the peripheral device section, even though read data read from the peripheral device section is inputted to the system LSI section, the read data is prohibited from being outputted from the system LSI section to the data bus, wherein the read data signal control section is provided inside the system LSI section.

In the system controller according to the present invention, when a read access request is issued from the external microcomputer section to the peripheral device section, the system LSI section retrieves read data read from the peripheral device section, sends out the retrieved read data to the system bus, and issues an acknowledge signal to the external microcomputer section, and the external microcomputer section receives the acknowledge signal from the system LSI section, and completes a read access.

In the system controller according to the present invention, the peripheral device section outputs an acknowledge signal at a completion of the access, and, when the system LSI section indirectly mediates a read access request from the external microcomputer section to the peripheral device section, each of the external microcomputer section and the system LSI section receives the acknowledge signal outputted from the peripheral device section, and completes a read access.

In the system controller according to the present invention, when the system LSI section indirectly mediates a write access request from the external microcomputer section to the peripheral device section, the system LSI section issues an acknowledge signal to the external microcomputer section to terminate the write access request from the external microcomputer section, and issues the write access request to the peripheral device section after acquiring the system bus.

In the system controller according to the present invention, the peripheral device section outputs an acknowledge signal at a completion of the access, and, when the system LSI section indirectly mediates a write access request from the external microcomputer section to the peripheral device section, the peripheral device section receives the acknowledge signal outputted from the peripheral device section, and completes a write access.

The system controller according to the present invention further comprises: a peripheral device section connected to the system bus, wherein the system control microcomputer of the external microcomputer section acquires the system bus by issuing a request to acquire the system bus to the arbitration section of the system LSI section, and then issues a direct access request to the system LSI section or the peripheral device section without operating the system control microcomputer of the system LSI section.

The system controller according to the present invention further comprises: an address strobe signal control section provided between the system LSI section and the external microcomputer section, wherein the address strobe signal control section validates an address strobe signal issued from the external microcomputer section only when an access request is issued from the external microcomputer section to the system LSI section.

In the system controller according to the present invention, the address strobe signal control section is embedded in the system LSI section.

In the system controller according to the present invention, the system LSI section is a system LSI having a digital television function incorporated therein, and the external microcomputer section is a microcomputer having an analog television function, a car navigation function, or a personal computer function.

Thus, in the system controller of the present invention, the system control microcomputer of the external microcomputer section can acquire the system bus by issuing a request to acquire the system bus to the arbitration section embedded in the system LSI section and obtaining a grant from the arbitration section. As a result, in association with execution of the function of the system LSI section, the external microcomputer section is allowed to directly issue a read or write access request via the system bus to the system LSI section or the peripheral device section or indirectly issue the read or write request via the system bus to the system LSI section or the peripheral device section through the mediation of the system control microcomputer of the system LSI section.

### Effect of the Invention

As described above, in the case of adding a system LSI having a new function to a system having an existing function, the present invention allows a large number of designers to perform system control using not only a system control microcomputer within the added system LSI but also a system control microcomputer within the existing system. This allows an increased flexibility in selecting a system control microcomputer, easy introduction of a system LSI having an attractive new function, and low-cost system construction, while allowing effective use of conventional design resources.

### BRIEF DESCRIPTION OF THE DRAWINGS

FIG. 1 is a view showing an entire structure of a system controller according to a first embodiment of the present invention;

FIG. 2 is a view showing a chart of a read access from an external microcomputer section to a system LSI section in the system controller;

FIG. 3 is a view showing a chart of a write access from the external microcomputer section to the system LSI section in the system controller;

FIG. 4 is a view showing a chart of a read access chart from the external microcomputer section to a peripheral device section in the system controller;

FIG. 5 is a view showing a chart of a write access from the external microcomputer section to the peripheral device section in the system controller;

FIG. 6 is a view showing an entire structure of a system controller according to a second embodiment of the present invention;

FIG. 7 is a view showing a chart of a read access from an external microcomputer section to a peripheral device section in a system controller according to a fifth embodiment of the present invention;

FIG. 8 is a view showing a chart of a write access from an external microcomputer section to a peripheral device section in a system controller according to a sixth embodiment of the present invention; and

FIG. 9 is a view showing an entire structure of a system controller according to an eighth embodiment of the present invention.

### DESCRIPTION OF NUMERALS

101, 601, 901 System LSI Section
101a, 901a Arbitration Section
102, 602, 902 External Microcomputer Section
103, 603, 903 Peripheral Device Section
104, 604, 904 System Bus
605 Acknowledge Signal Control Section
905 Address Strobe Signal Control Section

### BEST MODE FOR CARRYING OUT THE INVENTION

Referring to the drawings, the embodiments of the present invention will be described hereinbelow.

### Embodiment 1

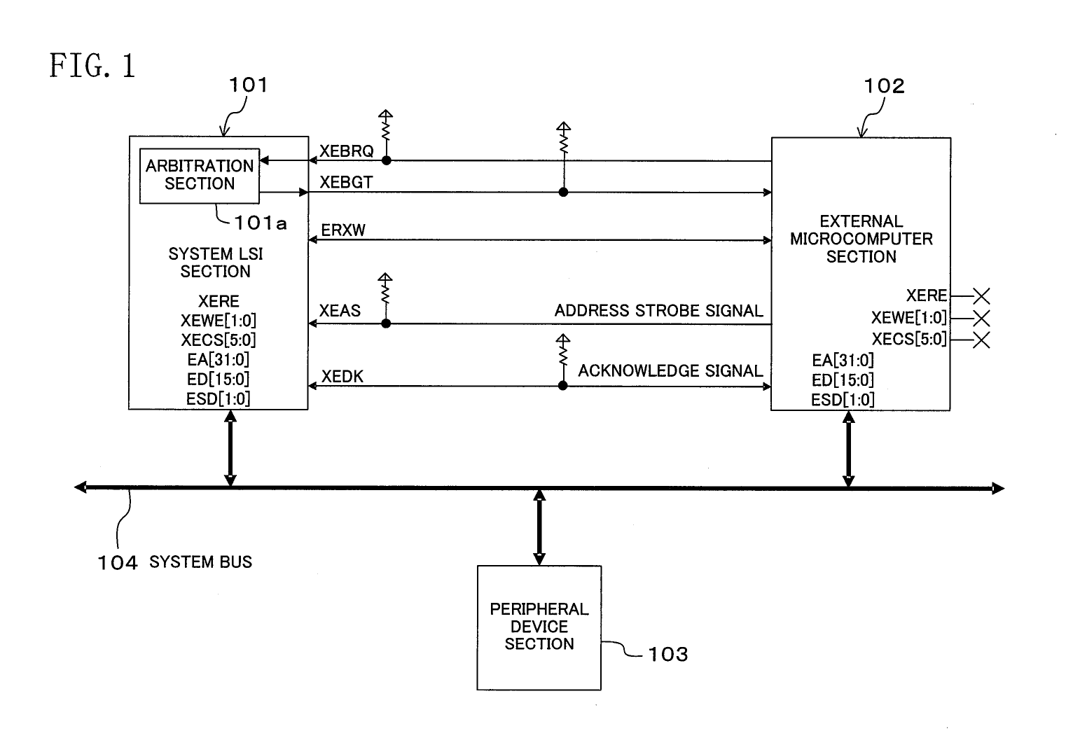

FIG. 1 shows an entire structure of a system controller according to the first embodiment of the present invention.

In the drawing, an external microcomputer section 102, a system LSI section 101, and a peripheral device section 103 are present on a system bus 104. The external microcomputer section 102 mentioned above is an already provided microcomputer which is, e.g., a microcomputer providing an analog television function or a car navigation function, or a microcomputer embedded in a personal computer. The system LSI section 101 mentioned above is integrated in one chip with a function, such as a digital television function, and a system control microcomputer (not shown) incorporated therein. Additionally, the peripheral device section 103 mentioned above includes a system bus interface such as, e.g., a USB controller.

Signals flowing in the system bus 104 mentioned above are a 32-bit address signal (EA[31:0]), a 16-bit data signal (ED[15:0]), a read signal (XERE: negative logic), the total of two write signals (XEWE[1:0]; negative logic) each included on a per 1-byte basis, six chip select signals (XECS[5:0]: negative logic), and a size signal ESZ showing an access size. However, the numbers of the signals are variable in accordance with a system, and an example as a 16-bit data system is shown herein. Each of the address signal EA, data signal ED, and size signal ESZ mentioned above is transmitted from the external microcomputer section 102 and the system LSI section 101. The read signal XERE, the write signals XEWE, and the chip select signals XECS each mentioned above are for an access to the peripheral device section 103 mentioned above, and are outputted only from the system LSI section 101 and are not outputted from the external microcomputer section 102 in the present embodiment to allow a microcomputer embedded in the external microcomputer 102 to perform an access to the peripheral device section 103, not directly, but using a system control microcomputer within the system LSI section 101 in association with execution of at least a part of the function (e.g., digital television function) of the system LSI section 101.

The system LSI section 101 mentioned above is provided with an embedded arbitration section 101a and equipped with the following specifications. Specifically, the arbitration section 101a mentioned above performs a bus arbitration function of receiving, when the external microcomputer section 102 asserts a bus request signal (XEBRQ: negative logic) which is a bus request signal, the bus request signal XEBRQ, asserting a bus grant signal (XEBGT: negative logic) which is a bus release notification signal to the external microcomputer section 102 after the termination of the bus access in execution, and releasing the right to use the system bus 104 to the external microcomputer section 102.

When the bus grant signal XEBGT mentioned above is asserted and the right to use the system bus 104 is released to the external microcomputer section 102, the system LSI section 101 mentioned above brings each of the foregoing address signal EA, the data signal ED, and the size signal ESZ each mentioned above, an address strobe signal (XEAS: negative logic) indicating an address valid period, and a read/write signal (ERXW: Hi=Read Cycle, Low=Write Cycle) indicating either a read cycle or a write cycle into a high impedance state. This allows the system LSI section 101 to receive an access request from the external microcomputer 102. The access request from the external microcomputer 102 is performed as follows by using a system bus interface composed of the read/write signal ERXW, the address strobe signal XEAS, an acknowledge signal XEDK, and the system bus 104 after the external microcomputer 102 has acquired the system bus 104 using the arbitration section 101a.

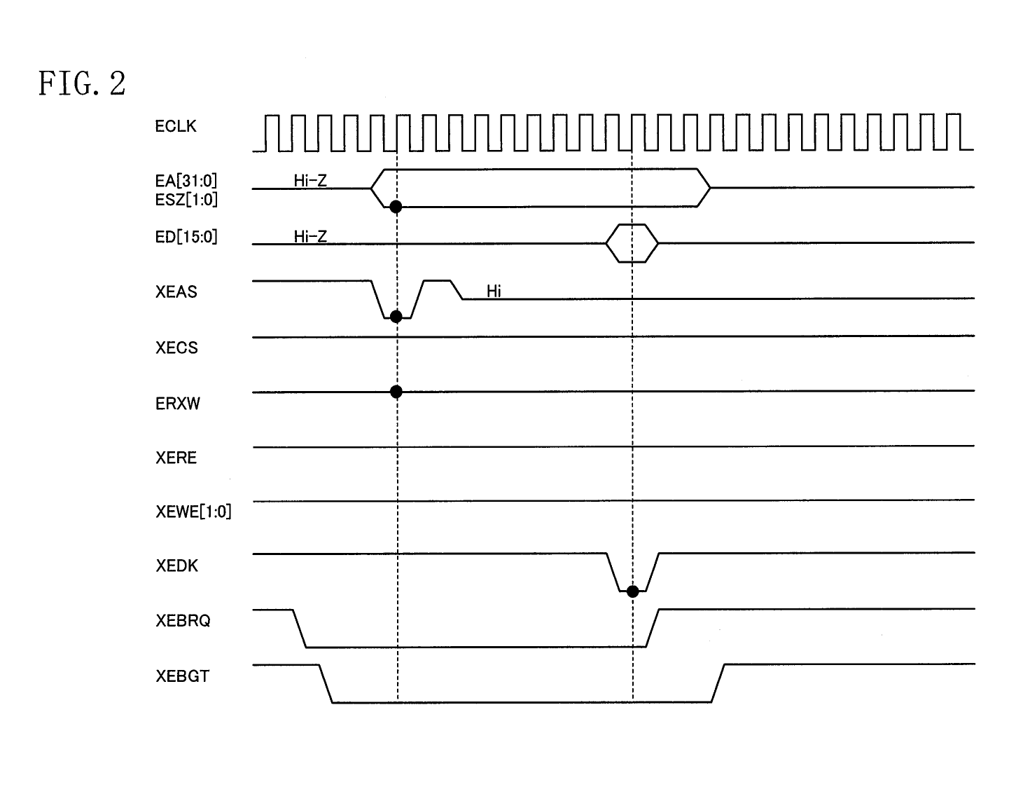

FIG. 2 shows an access chart when the external microcomputer section 102 performs a read access to the system LSI section 101 after acquiring the right to use the system bus 104. In the read access request shown in the drawing, the process is illustrated in which, after the external microcomputer 102 outputs the address signal EA, the size signal ESZ, and the address strobe signal XEAS, the system LSI section 101 outputs the read data ED, while outputting the acknowledge signal XEDK to the external microcomputer section 102, and terminates the read access.

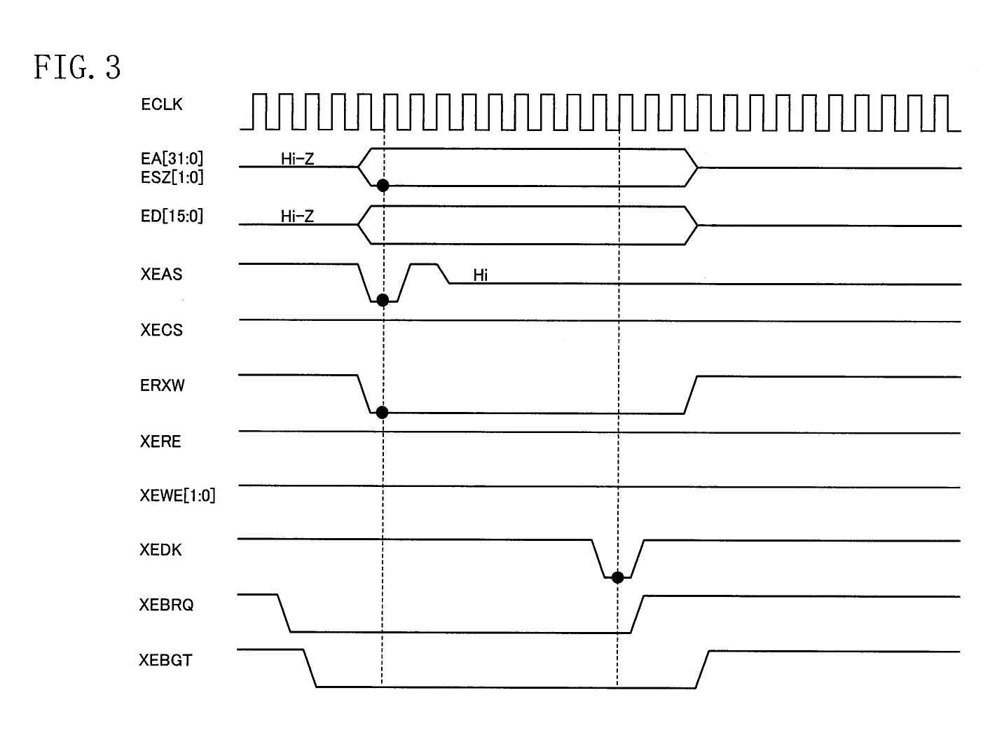

FIG. 3 shows an access chart when the external microcomputer section 102 performs a write access to the system LSI section 101 after acquiring the right to use the system bus 104. In the write access request shown in the drawing, the process is illustrated in which, after the external microcomputer section 102 outputs the address signal EA, the size signal ESZ, the write data ED, and the address strobe signal XEAS, the system LSI section 101 completes the operation of writing the data ED, outputs an acknowledge signal XEDK to the external microcomputer section 102, and terminates the write access.

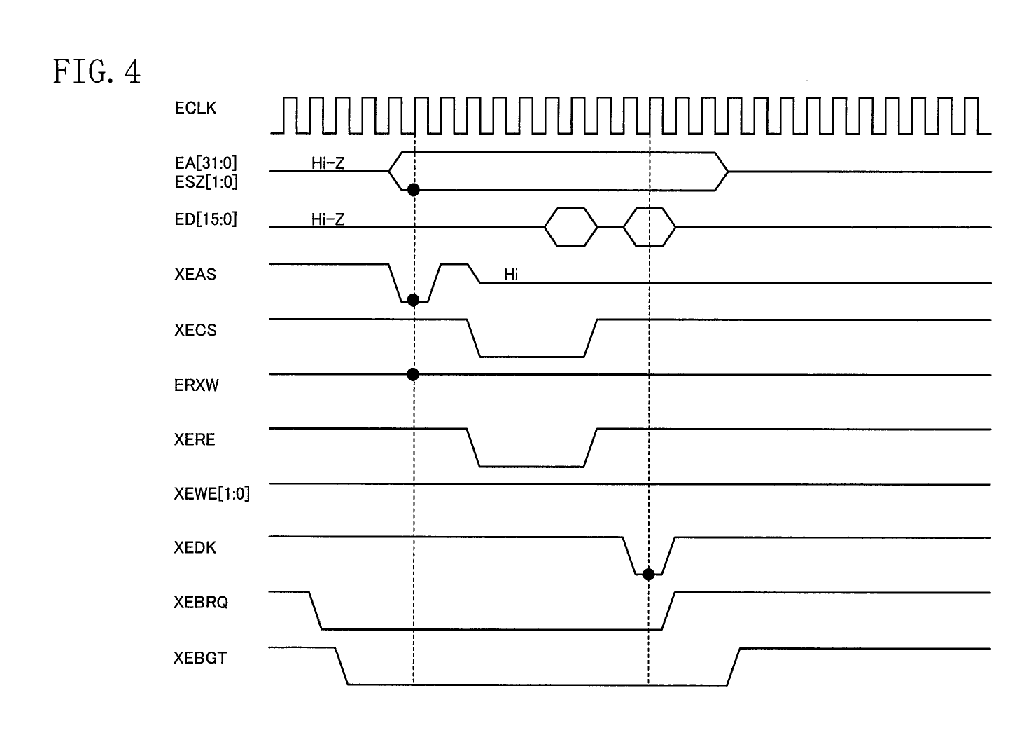

FIG. 4 shows a read cycle chart in which, after acquiring the right to use the system bus 104, the external microcomputer section 102 issues, to the system LSI section 101, a read access request to the peripheral device section 103 and, after receiving the access request, the system LSI section 101 performs a read access to the peripheral device section 103. In the process shown in the drawing, after acquiring the right to use the system bus 104, the external microcomputer section 102 outputs the address signal EA, the size signal ESZ, the read/write signal ERXW (High level), and the address strobe signal XEAS. Thereafter, when the system LSI section 101 outputs the chip select signals XECS specifying the peripheral device section 103 and the read signal XERE and the peripheral device section 103 outputs the read data ED to the system bus 104, the system LSI section 101 that has received the read data ED outputs the read data ED again to the system bus 104, while outputting the acknowledge signal XEDK to the external microcomputer section 102, so that the external microcomputer section 102 terminates the read access.

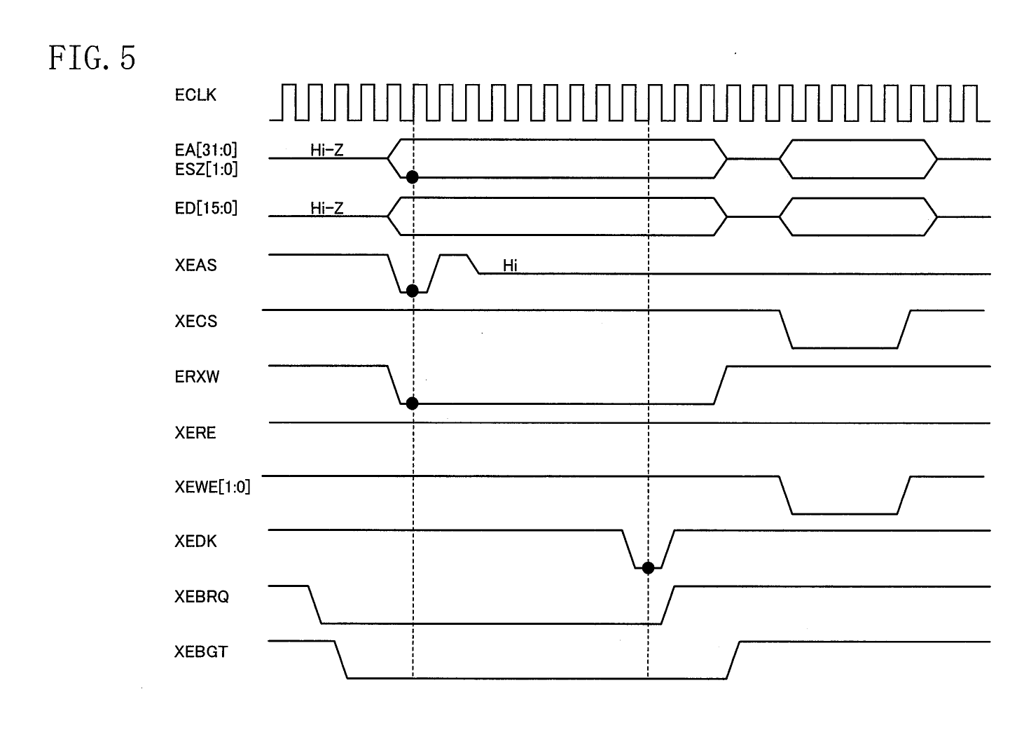

FIG. 5 shows a write cycle chart in which, after acquiring the right to use the system bus 104, the external microcomputer section 102 issues, to the system LSI section 101, a write access request to the peripheral device section 103, and the system LSI section 101 that has received the access request performs a write access to the peripheral device section 103. In the drawing, after the external microcomputer section 102 outputs the address signal EA, the size signal ESZ, the write data ED, the read/write signal ERXW (Low level), and the address strobe signal XEAS, the system LSI section 101 outputs the acknowledge signal XEDK, and the external microcomputer section 102 that has received the signal XEDK immediately terminates the write access. Thereafter, the system LSI section 101 outputs the signals received from the external microcomputer section 102 mentioned above, such as the write data ED, and the chip select signals XECS to the system bus 104 to write the write data ED to the peripheral device section 103.

### Embodiment 2

Next, a description will be given to the second embodiment of the present invention.

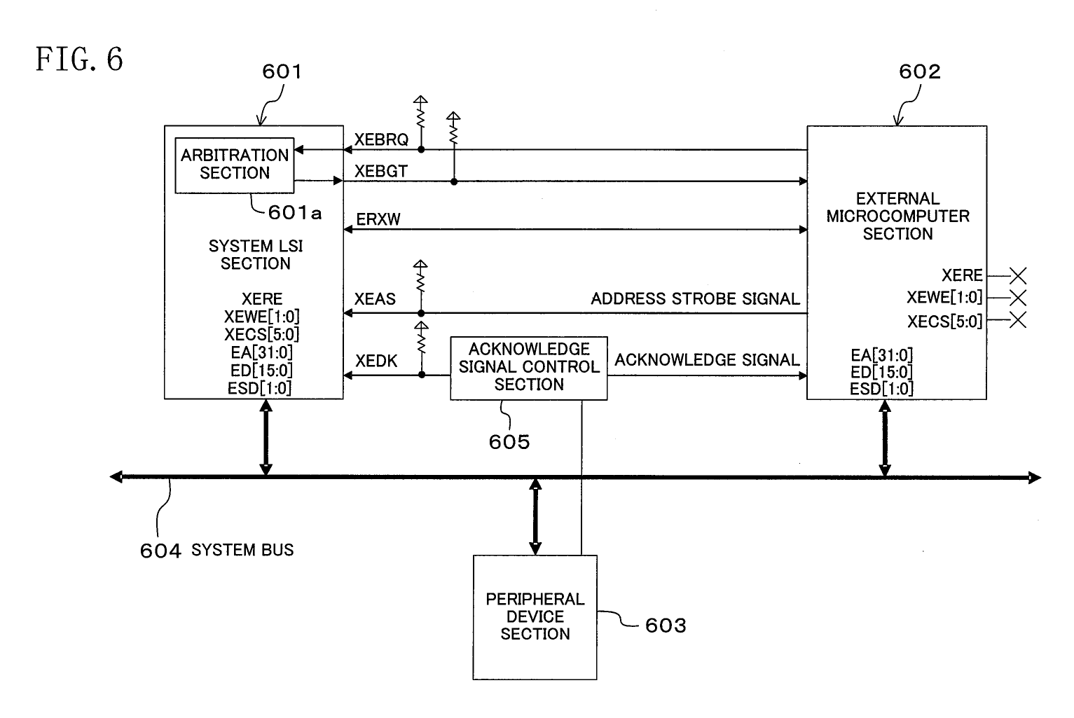

FIG. 6 shows an entire structure of a system controller according to the present embodiment. In the present embodiment, a system LSI section 601 having an arbitration section 601a, an external microcomputer section 602, and a system bus 604 are the same as in the first embodiment described above. The present embodiment is different from the first embodiment described above in that the peripheral device section 603 is a handshake device having the function of outputting an acknowledge signal, and an acknowledge signal control section 605 has been added.

A description will be given separately to the operation of the acknowledge signal control section 605 mentioned above when a read access request is issued and to that when a write access request is issued.

When the read access request is issued from the external microcomputer section 602 to the peripheral device section 603, the peripheral device section 603 outputs the read data and issues the acknowledge signal, and the acknowledge signal control section 605 passes the acknowledge signal to the external microcomputer section 602, whereby the external microcomputer section 602 terminates the read cycle. Thereafter, the system LSI section 601 that has received the read data ED from the peripheral device section 603 issues the read data ED again to the system bus 604, and outputs the acknowledge signal XEDK in the same manner as in the chart of FIG. 4, while the acknowledge signal control section 605 masks the outputting of the acknowledge signal to the external microcomputer section 602. Although the external device 602 receives the read data from the system LSI section 601, by setting a sufficient wait period, a data collision can be circumvented.

On the other hand, when a write access request is issued from the external microcomputer section 602 to the peripheral device section 603, the acknowledge signal control section 605 passes the acknowledge signal XEDK issued from the system LSI 601 to the external microcomputer section 602, whereby the external microcomputer section 602 terminates the write cycle. Thereafter, the system LSI section 601 issues a write access request to the peripheral device section 603. At that time, however, since the right to acquire the system bus 604 has been already shifted from the external microcomputer section 602 to the system LSI section 601, there is no misoperation in the system even when the peripheral device section 603 issues the acknowledge signal XEDK. However, the acknowledge signal XEDK issued from the peripheral device section 603 to the external microcomputer section 602 is preferably blocked by the acknowledge signal control section 605.

Thus, the present embodiment has the following advantages. That is, in the first embodiment described above, the peripheral device section 103 is a fixed-length device which does not have the function of outputting the acknowledge signal XEDK and determines the completion of an access based on the lapse of a set period. Therefore, a fixed-length access should be set to a peripheral device selection register present within the system LSI section 101. By contrast, in the present embodiment, the handshake device which outputs the acknowledge signal can be adopted as the peripheral device section 603. This allows an improved flexibility in selecting a device as the peripheral device section 603 and improves the flexibility of system design.

### Embodiment 3

Subsequently, a description will be given to the third embodiment of the present invention.

In the second embodiment described above, the acknowledge signal control section 605 is disposed outside the system LSI section 601. However, the present embodiment has adopted a structure in which the acknowledge signal control section 605 is embedded in the system LSI section 601.

Therefore, the present embodiment can provide a structure which is easy to construct in terms of system design.

### Embodiment 4

During the read cycle in the second embodiment described above, after receiving the read data from the peripheral device section 603, the system LSI section 601 issues the read data to the system bus 604. By contrast, the fourth embodiment has adopted a structure in which a read data control section (not shown) for preventing the received read data from being issued to the system bus 604 is provided and embedded in the system LSI section 601.

As a result, in the present embodiment, it is no more necessary for the external device 602 to be attentive to a data collision so that the effect of accordingly facilitating system design is obtained.

### Embodiment 5

Next, a description will be given to the fifth embodiment of the present invention.

The present embodiment has improved the operation when a read access request is issued from the external microcomputer section to the peripheral device section 103 in the case where the peripheral device section 103 is a handshake device.

That is, in FIG. 1, a register for setting the peripheral device section 103 to either the handshake device or to a fixed-length device is embedded in the system LSI section 101. The system LSI section 101 self-references the setting and recognizes that the peripheral device section 103 is the handshake device.

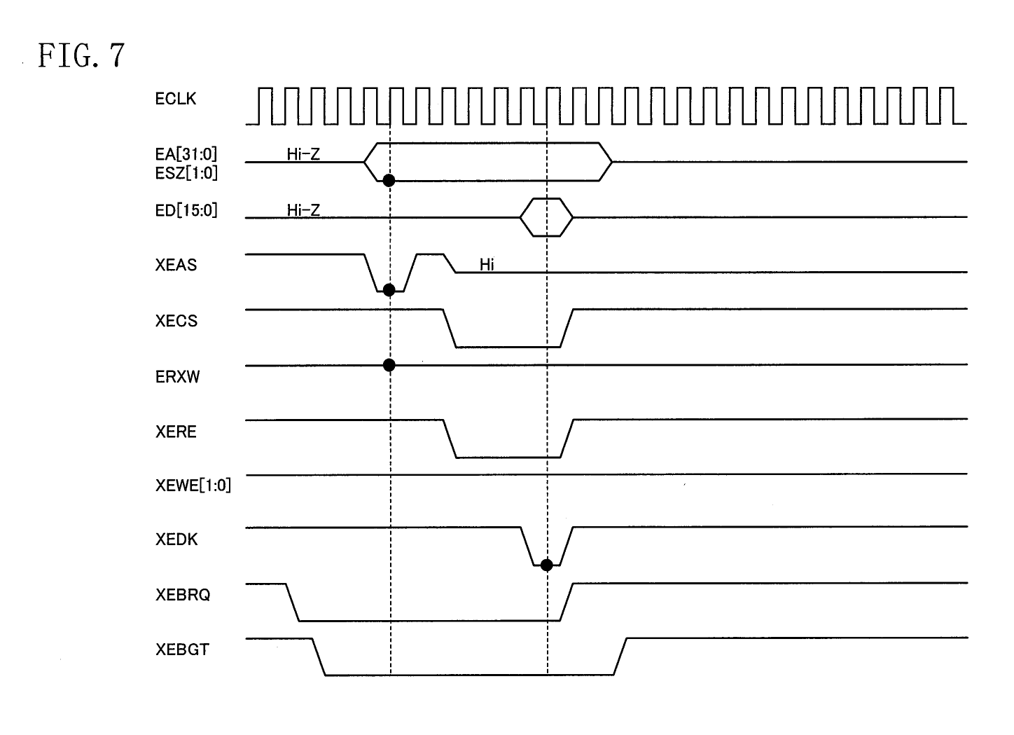

Then, as shown in FIG. 7, when a read access request is issued from the external microcomputer section 102 to the peripheral device section 103, the system LSI section 101 that has received the access request issues the chip select signals XECS corresponding to the peripheral device section 103, as described above, and additionally issues the read/write signal ERXW (High level). Thereafter, when the external device section 103 outputs the read data ED and issues the acknowledge signal XEDK, the system LSI section 101 and the external device section 102 that have received the acknowledge signal XEDK terminate the respective read cycles.

As a result, the present invention achieves, in addition to the effect achieved by the fourth embodiment described above, the effect of successfully saving the system LSI section 101 the need to perform the operation of outputting again the read data ED received from the peripheral device section 103 to the system bus 104 and accordingly improving an overhead during the read cycle via the system LSI section 101 by the time saved thereby, as can be seen from a comparison with the read cycle chart of FIG. 4.

### Embodiment 6

Next, a description will be given to the sixth embodiment of the present invention.

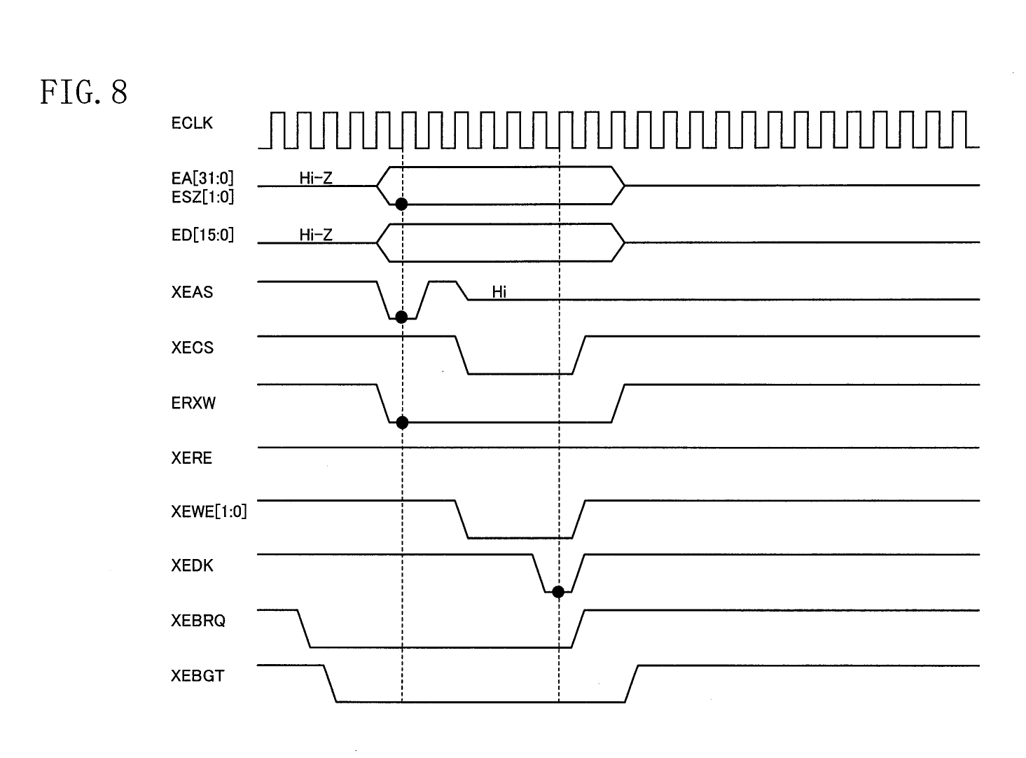

FIG. 8 shows a write access chart according to the sixth embodiment of the present invention. An entire structure of the system controller is the same as in FIG. 1.

In the write access chart shown above in FIG. 5, when a write access request is issued from the external microcomputer section 102 to the peripheral device section 103, the system LSI section 101 issues the acknowledge signal XEDK to terminate the access request from the external microcomputer section 102, and then newly generates a fixed-length access from the system LSI section 101 to the peripheral device section 103. Accordingly, the situation is that a 2-cycle write access seemingly occurs in accordance with the appearance of the system.

In the present embodiment, as shown in the write access chart of FIG. 8, when a write access request is issued from the external microcomputer section 102 to the peripheral device section 103, the system LSI section 101 issues the chip select signals XECS corresponding to the peripheral device section 103 and additionally issues the read/write signal XEWE (Low level) to write the write data ED from the external microcomputer section 102 to the peripheral device section 103. Thereafter, when the acknowledge signal XEDK is issued from the peripheral device section 103 that has completed the writing, the external microcomputer section 102 receives the acknowledge signal XEDK and terminates the write access request.

Thus, in the present embodiment, the write access that has seemingly occurred in two cycles in accordance with the appearance of the system can be accomplished in one cycle and the external microcomputer section 103 need not consider extra weight setting. This allows an effective improvement in overhead when the write cycle request is issued.

### Embodiment 7

The present embodiment achieves the optimization of the write access request in the sixth embodiment, similarly to the fifth embodiment described above.

That is, since the system LSI section 101 has the embedded register for setting the peripheral device section 103 to either the handshake device or the fixed-length device, the system LSI section 101 self-references the setting. In the case where the peripheral device section 103 is set to the handshake device, when a write access request is issued from the external microcomputer section 102 to the peripheral device section 103, the system LSI section 101 issues the chip select signals XECS corresponding to the peripheral device section 103 and additionally issues the read/write signal ERXW (Low level). When the external device section 103 writes the write data ED and issues the acknowledge signal XEDK, the system LSI section 101 and the external device section 102 that have received the acknowledge signal XEDK terminates the respective write cycles.

Thus, the system LSI section 101 improves the flexibility of device selection in setting the peripheral device section 103 to either the handshake device or the fixed-length device and can implement the write cycle using the same protocol as used for the read cycle. This significantly facilitates design in performing mounting. In addition, the external microcomputer section 103 can establish a complete handshake access and thereby effectively improve the overhead during the write cycle.

Since the present embodiment can also implement the fifth embodiment described above, the write access request can be optimized not only in terms of the design of the system LSI section 101, but also in terms of system design and system performance.

### Embodiment 8

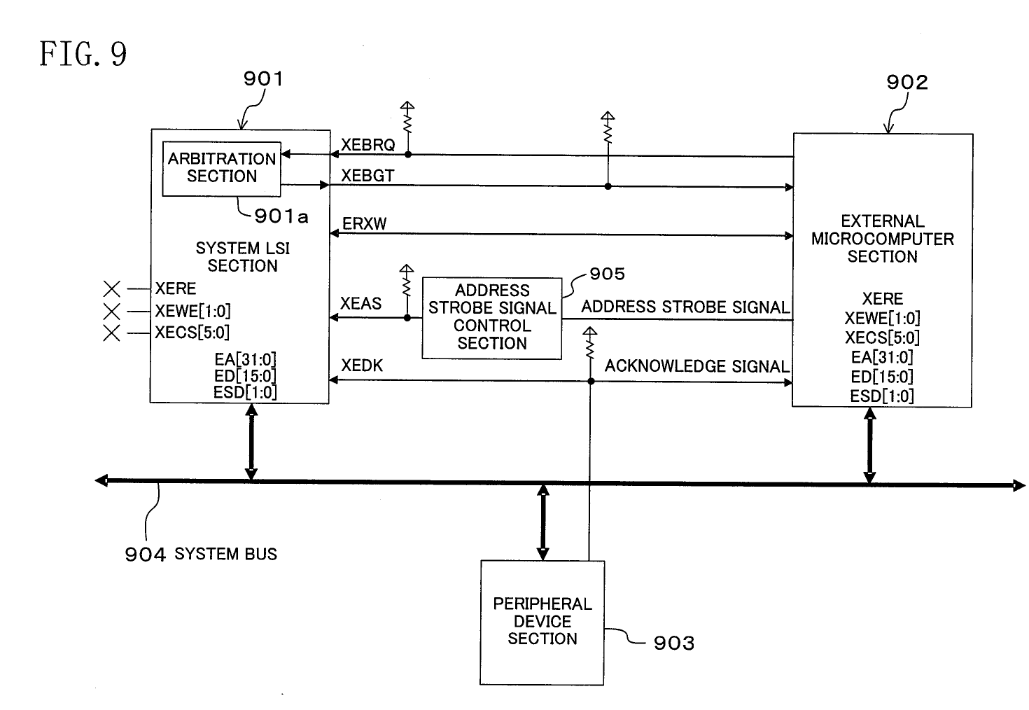

FIG. 9 shows an entire structure of a system controller according to the eighth embodiment of the present invention.

In the present embodiment, the system control microcomputer of a system LSI section 901 is not used. Instead, a microcomputer embedded in an external microcomputer section 902 serves as the system control microcomputer to directly control the system LSI section 901 and a peripheral device section 903.

That is, in FIG. 9, the system LSI section 901 having an arbitration section 901a, the external microcomputer section 902, and the peripheral device section 903 are disposed on a system bus 904 as already described, and there is also an address strobe control section 905. Because the microcomputer embedded in the external microcomputer section 902 serves as the system control microcomputer, the system LSI section 901 does not output the chip select signals XECS and the read/write signal XERE to the system bus 904. These signals are outputted from the external microcomputer section 902.

The address strobe control section 905 mentioned above validates the address strobe signal XEAS only when an access request is issued from the external microcomputer section 902 to the system LSI section 901. When an access request is issued from the external microcomputer section 902 to the peripheral device section 903, the address strobe control section 905 invalidates the address strobe signal XEAS. The system LSI section 901 performs the operation of only releasing the system bus 904 unless the address strobe signal XEAS is inputted from the external microcomputer section 902. As a result, it is possible to perform a direct access from the external device section 902 to the peripheral device section 903.

Thus, the present embodiment can eliminate the overhead attributable to an indirect read or write access via the system LSI section 901, i.e., the overhead resulting from the write access performed in two cycles shown in FIG. 5, as described above. This minimizes the length of one access cycle and improves system performance. Moreover, since the peripheral device 903 can be used not only as a fixed-length device but also as a handshake device, the flexibility of system design is improved.

### Embodiment 9

In the eighth embodiment described above, the address strobe signal control section 905 is disposed outside the system LSI section 901, as shown in FIG. 9. However, the address strobe signal control section 905 may also be disposed inside the system LSI section 901. In this case, a structure which is easy to construct in terms of system design can be provided.

### INDUSTRIAL APPLICABILITY

As described above, in the case of adding a system LSI having a new function to a system having an existing function, the present invention can increase the flexibility with which a large number of system designers select either a system control microcomputer within the existing system or a system control microcomputer within the added system LSI. Therefore, the present invention is useful as a system controller which allows low-cost system construction, while allowing effective use of conventional design resources.

1. A system controller comprising:
a system LSI section having a single or a plurality of functions integrated in one chip, and including an embedded system control microcomputer for controlling a system bus in association with execution of the functions; and
an external microcomputer section, wherein
the external microcomputer section has another system control microcomputer for controlling the system bus in association with execution of at least a part of the functions of the system LSI section.

2. The system controller of claim 1, wherein the system LSI section comprises:
an arbitration section for performing arbitration of an access to the system bus between itself and the external microcomputer section, wherein
the system LSI section and the external microcomputer section share the system bus, and either one of the system control microcomputers controls the system bus through the access arbitration by the arbitration section.

3. The system controller of claim 2, wherein the system LSI section receives an access request from the external microcomputer section using the arbitration section and a system bus interface, and controls a part of the functions of the system LSI section in response to the access request at a reception time thereof.

4. The system controller of claim 2, further comprising:
a peripheral device section connected to the system bus, wherein
the system bus LSI section receives an access request from the external microcomputer section to the peripheral device section using the arbitration section and a system bus interface, and performs an access to the peripheral device section in response to the access request at a reception time thereof.

5. The system controller of claim 4, wherein the system LSI section and the peripheral device section output respective acknowledge signals at a completion of the access,
the system controller further comprising:
an acknowledge signal control section for controlling the acknowledge signals outputted from the system LSI section and from the peripheral device section such that the acknowledge signals are not inputted to the external microcomputer section.

6. The system controller of claim 5, wherein the acknowledge signal control section is provided inside the system LSI section.

7. The system controller of claim 6, further comprising:
a read data signal control section for performing a control operation such that, when a read access request for data is issued from the external microcomputer section to the peripheral device section, even though read data read from the peripheral device section is inputted to the system LSI section, the read data is prohibited from being outputted from the system LSI section to the data bus, wherein
the read data signal control section is provided inside the system LSI section.

8. The system controller of claim 4, wherein,
when a read access request is issued from the external microcomputer section to the peripheral device section,
the system LSI section retrieves read data read from the peripheral device section, sends out the retrieved read data to the system bus, and issues an acknowledge signal to the external microcomputer section, and
the external microcomputer section receives the acknowledge signal from the system LSI section, and completes a read access.

9. The system controller of claim 4, wherein the peripheral device section outputs an acknowledge signal at a completion of the access, and,
when the system LSI section indirectly mediates a read access request from the external microcomputer section to the peripheral device section,
each of the external microcomputer section and the system LSI section receives the acknowledge signal outputted from the peripheral device section, and completes a read access.

10. The system controller of claim 4, wherein,
when the system LSI section indirectly mediates a write access request from the external microcomputer section to the peripheral device section,
the system LSI section issues an acknowledge signal to the external microcomputer section to terminate the write access request from the external microcomputer section, and issues the write access request to the peripheral device section after acquiring the system bus.

11. The system controller of claim 4, wherein the peripheral device section outputs an acknowledge signal at a completion of the access, and,
when the system LSI section indirectly mediates a write access request from the external microcomputer section to the peripheral device section,
the peripheral device section receives the acknowledge signal outputted from the peripheral device section, and completes a write access.

12. The system controller of claim 2, further comprising:
a peripheral device section connected to the system bus, wherein
the system control microcomputer of the external microcomputer section acquires the system bus by issuing a request to acquire the system bus to the arbitration section of the system LSI section, and then issues a direct access request to the system LSI section or the peripheral device section without operating the system control microcomputer of the system LSI section.

13. The system controller of claim 12, further comprising:
an address strobe signal control section provided between the system LSI section and the external microcomputer section, wherein
the address strobe signal control section validates an address strobe signal issued from the external microcomputer section only when an access request is issued from the external microcomputer section to the system LSI section.

14. The system controller of claim 13, wherein the address strobe signal control section is embedded in the system LSI section.

15. The system controller of claim 1, wherein
the system LSI section is a system LSI having a digital television function incorporated therein, and
the external microcomputer section is a microcomputer having an analog television function, a car navigation function, or a personal computer function.
